(19) United States
(12) Patent Application Publication
(10) Pub. No.: US 2010/0203328 A1
(43) Pub. Date: Aug. 12, 2010

(54) METHOD FOR IMPREGNATING CONTINUOUS FIBRES WITH A COMPOSITE POLYMER MATRIX CONTAINING A THERMOPLASTIC POLYMER

(75) Inventors: Gilles Hochstetter, Bernay (FR); Michael Werth, Bernay (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 12/666,536

(22) PCT Filed: Jun. 27, 2008
(86) PCT No.: PCT/FR2008/051187

§ 371 Date: Dec. 23, 2009

(30) Foreign Application Priority Data
Jun. 27, 2007 (FR) 0704620

(51) Int. Cl. B32B 9/00

(52) U.S. Cl. 428/368; 428/375; 977/742

(57) ABSTRACT

The invention relates to a method for the impregnation of continuous fibers, that comprises coating said fibers with a polymer matrix containing at least one thermoplastic semicrystalline polymer having a glass transition temperature (T_{g}) lower than or equal to 130° C., and nanotubes of at least one chemical element selected from the elements of the columns IIIa, IVa and Va of the periodic table. The invention also relates to the composite fibres that can be obtained by said method, and to the use thereof.”

The present invention relates to a method for impregnating continuous fibers, comprising the coating of said fibers with a polymer matrix comprising at least one semicrystalline thermoplastic polymer having a glass transition temperature (T_{g}) less than or equal to 130° C. and nanotubes of at least one chemical element chosen from the elements from columns IIIa, IVa and Va of the Periodic Table. It also relates to the composite fibers capable of being obtained according to this method, and also to the uses thereof.

Composites are the subject of intensive research, insofar as they have many functional advantages (lightness, mechanical strength and chemical resistance, freedom of form) allowing them to take the place of metal in very diverse applications.

Use has also been made in recent years of composite fibers for manufacturing, in particular, various aeronautical or motor vehicle components. These composite fibers, which are characterized by good thermomechanical strength and chemical resistance, are formed from a filament reinforcement that farms armoring, intended for providing the mechanical strength of the material, and from a matrix that binds and coats the reinforcing fibers, intended for distributing the stresses (tensile strength, flexural strength or compressive strength), for giving the material chemical protection in certain cases and for giving it its shape.

The processes for manufacturing composite components from these coated fibers include various techniques such as, for example, contact molding, spray molding, autoclave lay-up molding or low-pressure molding.

One technique for producing hollow components is that known as filament winding, which consists in impregnating dry fibers with a resin and then in winding them on a mandrel formed from armoring and having a shape adapted to the component to be manufactured. The component obtained by winding is then heat-cured. Another technique, for making plates or hulls, consists in impregnating fabrics with fibers and then pressing them in a mold in order to consolidate the laminated composite obtained.

Research has been conducted in order to optimize the composition of the impregnation resin so that it is liquid enough to impregnate the fibers, without, however, leading to running when the fibers are removed from the bath.

An impregnation composition has thus been proposed, containing a thermosetting resin (such as an epoxide resin, for example bisphenol A diglycidyl ether, associated with a hardener) combined with a particular rheology control agent, which is miscible with said resin, such that the composition has Newtonian behavior at high temperature (40 to 150° C.). The rheology control agent is preferably a block polymer comprising at least one block that is compatible with the resin, such as a methyl methacrylate homopolymer or a copolymer of methyl methacrylate with, in particular, dimethylacrylamide, a block that is incompatible with the resin, formed, for example, from 1,4-butadiene or n-butyl acrylate monomers, and optionally a polystyrene block. As a variant, the rheology control agent may comprise two blocks that are incompatible with each other and with the resin, such as a polystyrene block and a poly(1,4-butadiene) block.

Although this solution effectively makes it possible to overcome the drawbacks of the prior art on account of the Newtonian nature of the composition and of its viscosity suited to coating at high temperature, and also on account of its pseudoplastic nature at low temperature, it is limited to the production of composites based on thermosetting resin that is not readily thermoformable, in contrast with thermoplastic polymers, the composites obtained also having a limited impact strength and shelf life.

Another solution using a thermoplastic coating composition consists in coating the fibers with a polyether ether ketone (PEEK), with poly(phenylene sulfide) (PPS) or with polyphenyl sulfone (PPSU), for example.

The use of these coating materials is sometimes problematic due to their cost. Moreover, they pose processing problems due to the impossibility of making them melt below 270° C., which also affects the economics of the process since they require a relatively high consolidation temperature of the composite, requiring a high energy input.

The need remains therefore to propose a method for impregnating continuous fibers with a thermoplastic polymer matrix, which method is more economical to implement than the known methods while allowing composite fibers to be obtained that have suitable mechanical properties, especially for aeronautical and motor vehicle applications.

The Applicant has discovered that this need could be satisfied by the use of a particular polymer reinforced with nanotubes.

One subject of the present invention is more specifically a method for impregnating continuous fibers, comprising the coating of said fibers with a polymer matrix comprising at least one semicrystalline thermoplastic polymer having a glass transition temperature (T_{g}) less than or equal to 130° C. and nanotubes of at least one chemical element chosen from the elements from columns IIIa, IVa and Va of the Periodic Table.

Another subject of the present invention is the composite fibers capable of being obtained according to this method.

Firstly, it is specified that in the whole of this description, the expression “between” should be interpreted as including the limits mentioned.

The method according to the invention therefore relates to the impregnation of continuous fibers.

Examples of constituent materials of said fibers include, without limitation:
drawn polymer fibers, especially based: on polyamide such as polyamide 6 (PA-6), polyamide 11 (PA-11), polyamide 12 (PA-12), polyamide 6,6 (PA-6,6), polyamide 4,6 (PA-4,6), polyamide 6,10 (PA-6,10) or polyamide 6,12 (PA-6,12), polyether/block polyamide copolymer (Pebax®), on high-density polyethylene, on polypropylene or on polyester such as the polyhydroxy-alkanoates and the polyesters sold by DU PONT under the trade name Hytrel®;
carbon fibers;
glass fibers, especially of E, R or S2 type;
aramid fibers (Kevlar®);
boron fibers;
silica fibers;
natural fibers such as linen, hemp or sisal; and
mixtures thereof, such as the mixtures of glass, carbon and aramid fibers.

The coating composition used according to the present invention comprises at least one semicrystalline thermoplastic polymer having a glass transition temperature (T_{g}) less than or equal to 130° C.

Such a polymer may especially be chosen, without limitation, from:
polyamides such as polyamide 6 (PA-6), polyamide 11 (PA-11), polyamide 12 (PA-12), polyamide 6,6 (PA-6, 6) , polyamide 4,6 (PA-4, 6) , polyamide 6,10 (PA-6,10) or polyamide 6,12 (PA-6,12), some of these polymers being, in particular, sold by ARKEMA under the name Rilsan® and the preferred ones being those of fluid grade such as Rilsan® AMNO TLD, and also copolymers, especially block copolymers, containing amide monomers and other monomers such as polytetramethylene glycol (PTMG) (sold by ARKEMA under the name Pebax®);
aromatic polyamides such as polyphthalamides;
fluoropolymers comprising at least 50 mol %, and preferably constituted, of monomers of formula (I):

CFX═CHX′tm (I)

where X and X′ independently denote a hydrogen or halogen atom (in particular fluorine or chlorine) or a perhalogenated (in particular perfluorinated) alkyl radical, and preferably X═F and X′═H, such as polyvinylidene fluoride (PVDF), preferably in α form, copolymers of vinylidene fluoride with, for example, hexafluoropropylene (HFP), fluoroethylene/propylene (FEP) copolymers, copolymers of ethylene with either fluoroethylene/propylene (FEP), or tetrafluoroethylene (TFE), or perfluoromethyl vinyl ether (PMVE), or chlorotrifluoroethylene (CTFE), some of these polymers being, in particular, sold by ARKEMA under the name Kynar® and the preferred ones being those of injection-molding grade such as Kynar® 710 or 720;
polyolefins such as polyethylene and poly-propylene;
thermoplastic polyurethanes (TPUs);
polyethylene terephthalates or polybutylene terephthalates;
silicone polymers; and
mixtures thereof.

The glass transition temperatures of a few polymers that can be used according to the invention are given in Table 1 below.

TABLE 1

| Polymer | T_{g} (° C.) |
|---|---|
| PA-11 | 50 |
| α-PVDF | −40 |
| Polyethylene | −110 |
| Pebax ® | 20 |
| TPU | <110 |

It is understood that the thermoplastic polymer may be made from the same material as that constituting the continuous fibers, in which case a composite is obtained that is referred to as “self-reinforced” (or SRP for “self-reinforced polymer”).

The polymer matrix used according to the invention contains, besides the thermoplastic polymer mentioned above, nanotubes of at least one chemical element chosen from the elements from columns IIIa, IVa and Va of the Periodic Table. These nanotubes may be based on carbon, boron, phosphorus and/or nitrogen (borides, nitrides, carbides, phosphides) and may, for example, be constituted of carbon nitride, boron nitride, boron carbide, boron phosphide, phosphorus nitride or carbon boronitride. Carbon nanotubes (hereinbelow CNTs) are preferred for use in the present invention.

The nanotubes that can be used according to the invention may be of the single-walled, double-walled or multi-walled type. The double-walled nanotubes may, in particular, be prepared as described by Flahaut et al. in Chem. Com. (2003), 1442. The multi-walled nanotubes may, for their part, be prepared as described in document WO 03/02456.

The nanotubes customarily have an average diameter ranging from 0.1 to 200 nm, preferably from 0.1 to 100 nm, more preferably from 0.4 to 50 nm and, better still, from 1 to 30 nm and advantageously a length from 0.1 to 10 μm. Their length/diameter ratio is preferably greater than 10 and usually greater than 100. Their specific surface area is, for example, between 100 and 300 m²/g and their bulk density may especially be between 0.05 and 0.5 g/cm³ and more preferably between 0.1 and 0.2 g/cm³. The multi-walled nanotubes may, for example, comprise from 5 to 15 layers and more preferably from 7 to 10 layers.

An example of crude carbon nanotubes is, in particular, available commercially from ARKEMA under the trade name Graphistrength® C100.

These nanotubes may be purified and/or treated (for example oxidized) and/or milled and/or functionalized, before their use in the method according to the invention.

The milling of the nanotubes may especially be performed at low temperature or at high temperature and be carried out according to the known techniques used in equipment such as ball mills, hammer mills, grinding mills, knife mills, gas-jet mills or any other grinding system capable of reducing the size of the entangled network of nanotubes. It is preferred that this grinding step is carried out according to a gas-jet grinding technique and in particular in an air-jet mill.

The purification of crude or milled nanotubes may be carried out by washing using a solution of sulfuric acid, so as to rid them of possible residual mineral and metallic impurities, originating from their preparation process. The weight ratio of the nanotubes to the sulfuric acid may especially be between 1:2 and 1:3. The purification operation may furthermore be carried out at a temperature ranging from 90 to 120° C., for example for a duration of 5 to 10 hours. This operation may advantageously be followed by steps of rinsing with water and of drying of the purified nanotubes.

The oxidation of the nanotubes is advantageously carried out by bringing the latter into contact with a solution of sodium hypochlorite containing from 0.5 to 15% by weight of NaOCl and preferably from 1 to 10% by weight of NaOCl, for example in the weight ratio of the nanotubes to the sodium hypochlorite that ranges from 1:0.1 to 1:1. The oxidation is advantageously carried out at a temperature of less than 60° C. and preferably at ambient temperature, for a duration that ranges from a few minutes to 24 hours. This oxidation operation may advantageously be followed by steps of filtration and/or centrifugation, washing and drying of the oxidized nanotubes.

The functionalization of the nanotubes may be carried out by grafting reactive units such as vinyl monomers to the surface of the nanotubes. The constituent material of the nanotubes is used as a radical polymerization initiator after having been subjected to a heat treatment at more than 900° C., in an anhydrous and oxygen-free medium, which is intended to remove the oxygenated groups from its surface. It is thus possible to polymerize methyl methacrylate or hydroxyethyl methacrylate at the surface of carbon nanotubes with a view to facilitating, in particular, their dispersion in PVDF or polyamides.

Use is preferably made, in the present invention, of crude, optionally milled, nanotubes, that is to say of nanotubes which are neither oxidized nor purified nor functionalized and that have not undergone any other chemical treatment.

The nanotubes may represent from 0.5 to 30% and preferably from 0.5 to 10%, and more preferably still from 1 to 5% of the weight of the thermoplastic polymer.

It is preferred that the nanotubes and the thermoplastic polymer are mixed by compounding using customary devices such as twin-screw extruders or co-kneaders. In this process, polymer granules are typically melt-blended with the nanotubes.

As a variant, the nanotubes may be dispersed by any appropriate means in the thermoplastic polymer which is in solution in a solvent. In this case, the dispersion may be improved, according to one advantageous embodiment of the present invention, by the use of specific dispersion systems or dispersants.

Thus, in the case of a solvent-route dispersion, the method according to the invention may comprise a preliminary step of dispersion of the nanotubes in the thermoplastic polymer by means of ultrasounds or of a rotor-stator system.

Such a rotor-stator system is especially sold by SILVERSON under the trade name Silverson® L4RT. Another type of rotor-stator system is sold by IKA-WERKE under the trade name Ultra-Turrax®.

Yet other rotor-stator systems are constituted of colloid mills, deflocculating turbines and high-shear mixers of rotor-stator type, such as the machines sold by IKA-WERKE or by ADMIX.

The dispersants may especially be chosen from plasticizers which may themselves be chosen from the group constituted of:
alkyl phosphate esters, hydroxybenzoic acid (the preferably linear alkyl group of which contains from 1 to 20 carbon atoms), lauric acid, azelaic acid or pelargonic acid;
phthalates, especially dialkyl or alkylaryl, in particular alkylbenzyl, phthalates, the linear or branched alkyl groups independently containing from 1 to 12 carbon atoms;
adipates, especially dialkyl adipates;
sebacates, especially dialkyl and in particular dioctyl sebacates, in particular in the case where the polymer matrix contains a fluoropolymer;
benzoates of glycols or of glycerol;
dibenzyl ethers;
chloroparaffins;
propylene carbonate;
sulfonamides, in particular in the case where the polymer matrix contains a polyamide, especially aryl sulfonamides, the aryl group of which is optionally substituted by at least one alkyl group containing from 1 to 6 carbon atoms, such as benzene sulfonamides and toluene sulfonamides, which may be N-substituted or N,N-disubstituted by at least one, preferably linear, alkyl group containing from 1 to 20 carbon atoms;
glycols; and
mixtures thereof.

As a variant, the dispersant may be a copolymer comprising at least one anionic hydrophilic monomer and at least one monomer that includes at least one aromatic ring, such as the copolymers described in document FR-2 766 106, the weight ratio of the dispersant to the nanotubes preferably ranging from 0.6:1 to 1.9:1.

In another embodiment, the dispersant may be a homopolymer or a copolymer of vinylpyrrolidone, the weight ratio of the nanotubes to the dispersant preferably ranging, in this case, from 0.1 to less than 2.

In yet another embodiment, the dispersion of the nanotubes in the polymer matrix may be improved by bringing these nanotubes into contact with at least one compound A which may be chosen from various polymers, monomers, plasticizers, emulsifiers, coupling agents and/or carboxylic acids, the two components (nanotubes and compound A) being mixed in the solid state or the mixture being in pulverulent form, optionally after removal of one or more solvents.

The polymer matrix used according to the invention may furthermore contain at least one adjuvant chosen from plasticizers, antioxidants, light stabilizers, colorants, impact modifiers, anti-static agents, flame retardants, lubricants, and mixtures thereof.

Preferably, the volume ratio of the continuous fibers to the polymer matrix (including the thermoplastic polymer and the nanotubes) is greater than or equal to 50% and preferably greater than or equal to 60%.

The coating of the fibers by the polymer matrix may be carried out according to various techniques, depending in particular on the physical form of the matrix (pulverulent or more or less liquid) and of the fibers. The fibers may be used as is, in the form of unidirectional yarns, or after a weaving step, in the form of fabric constituted of a bidirectional network of fibers. The coating of the fibers is preferably carried out according to a fluidized bed impregnation process, in which the polymer matrix is in the powder form. In a less preferred variant, the coating of the fibers may be carried out by passage in an impregnating bath containing the polymer matrix in the melt state. The polymer matrix then solidifies around the fibers in order to form a semi-finished product constituted of a pre-impregnated strip of fibers capable of then being wound up or of a pre-impregnated fabric of fibers.

These semi-finished products are then used in the manufacture of the desired composite component. Various pre-impregnated fabrics of fibers, of identical or different composition, may be laminated to form a sheet or a laminated material, or as a variant subjected to a thermoforming process. The strips of fibers may be used in a filament-winding process that makes it possible to obtain hollow components of almost unlimited shape. In the latter process, the fibers are wound around a mandrel having the shape of the component to be manufactured. In all cases, the manufacture of the finished component comprises a step of consolidation of the polymer matrix, which is for example locally melted in order to create regions for fastening fibers to one another and attaching the strips of fibers in the filament-winding process.

As another variant, it is possible to prepare a film from the polymer matrix, especially by means of an extrusion or calendering process, said film having, for example, a thickness of around 100 μm, then in placing it between two mats of fibers, the assembly then being hot-pressed in order to allow the impregnation of the fibers and the manufacture of the composite.

The composite fibers obtained as described previously find an interest in various applications, due to their high modulus (typically greater than 50 GPa) and their high strength, which is expressed by a tensile strength of greater than 200 MPa at 23° C.

One subject of the present invention is more specifically the use of the aforementioned composite fibers for the manufacture of noses, wings or cockpits of rockets or of aircraft; of sheathings for offshore hose; of motor vehicle body components, engine chassis or support parts for a motor vehicle; or of framework components in the field of construction or bridges and roadways.

The invention will now be illustrated by the following non-limiting examples.

### EXAMPLES

### Example 1

### Method for Manufacturing Laminated Composite Sheets Using Carbon Fibers Coated with PA-11/CNTs

Composite carbon nanotubes (CNTs) are manufactured by adding firstly 21 g of carbon nanotubes (Graphistrength® C100) to 800 g of methylene chloride, then by carrying out an ultrasound treatment using a Sonics & Materials VC-505 unit set at an amplitude of 50% for around 4 hours, with continuous stirring using a magnetic stirrer bar. Next, 64 g of cyclic butylene terephthalate (CBT) are introduced. The mixture is passed into a roll mill for around 3 days, then poured onto a sheet of aluminum and the solvent is evaporated. The resulting powder contains around 25% by weight of CNTs.

These composite nanotubes are then added to polyamide-11 (Rilsan® BMNO PCG), in a CNTs/CBT/PA-11 proportion of 5/15/80, by melt-blending on a DSM midi-extruder, the extrusion parameters being the following: temperature: 210° C.; speed: 75 rpm; duration: 10 minutes. A composite matrix is then obtained that is used for coating, in a fluidized bed, fabrics of continuous carbon fibers before transferring the pre-impregnated fabrics of fibers, via a guidance system, to a press suitable for the manufacture of a laminated composite sheet. Subjecting the pre-impregnated fabrics to a hot-pressing operation (temperature of around 180-190° C.) allows the consolidation of the composite.

### Example 2

### Method for Manufacturing Laminated Composite Sheets Using Carbon Fibers Coated with PA-12/CNTs

Composite carbon nanotubes (CNTs) are manufactured by adding firstly 21 g of carbon nanotubes (Graphistrength® C100) to 800 g of methylene chloride, then by carrying out an ultrasound treatment using a Sonics & Materials VC-505 unit set at an amplitude of 50% for around 4 hours, with continuous stirring using a magnetic stirrer bar. Next, 64 g of cyclic butylene terephthalate (CBT) are introduced. The mixture is passed into a roll mill for around 3 days, then poured onto a sheet of aluminum and the solvent is evaporated. The resulting powder contains around 25% by weight of CNTs.

These composite nanotubes are then added to polyamide-11 (Rilsan® BMNO PCG), in a CNTs/CBT/PA-12 proportion of 5/15/80, by melt-blending on a DSM midi-extruder, the extrusion parameters being the following: temperature: 210° C.; speed: 75 rpm; duration: 10 minutes. A composite matrix is then obtained that is used for coating, in a fluidized bed, fabrics of continuous carbon fibers before transferring the pre-impregnated fabrics of fibers, via a guidance system, to a press suitable for the manufacture of a laminated composite sheet. Subjecting the pre-impregnated fabrics to a hot-pressing operation (temperature of around 180-190° C.) allows the consolidation of the composite.

### Example 3

### Method for Manufacturing Laminated Composite Sheets Using Carbon Fibers Coated with Pebax®/CNTs

Composite carbon nanotubes (CNTs) are manufactured by adding firstly 21 g of carbon nanotubes (Graphistrength® C100) to 800 g of methylene chloride, then by carrying out an ultrasound treatment using a Sonics & Materials VC-505 unit set at an amplitude of 50% for around 4 hours, with continuous stirring using a magnetic stirrer bar. Next, 64 g of cyclic butylene terephthalate (CBT) are introduced. The mixture is passed into a roll mill for around 3 days, then poured onto a sheet of aluminum and the solvent is evaporated. The resulting powder contains around 25% by weight of CNTs.

These composite nanotubes are then added to polyamide-11 (Rilsan® BMNO PCG), in a CNTs/CBT/Pebax® proportion of 5/15/80, by melt-blending on a DSM midi-extruder, the extrusion parameters being the following: temperature: 210° C.; speed: 75 rpm; duration: 10 minutes. A composite matrix is then obtained that is used for coating, in a fluidized bed, fabrics of continuous carbon fibers before transferring the pre-impregnated fabrics of fibers, via a guidance system, to a press suitable for the manufacture of a laminated composite sheet. Subjecting the pre-impregnated fabrics to a hot-pressing operation (temperature of around 180-190° C.) allows the consolidation of the composite.

1. A method for impregnating continuous fibers, comprising coating of said fibers with a polymer matrix comprising at least one semicrystalline thermoplastic polymer having a glass transition temperature (T_{g}) less than or equal to 130° C. and nanotubes of at least one chemical element chosen from the elements from columns IIIa, IVa and Va of the Periodic Table.

2. The method as claimed in claim 1, wherein said continuous fibers are chosen from:
drawn polymer fibers,
carbon fibers;
glass fibers;
aramid fibers;
boron fibers;
silica fibers;
natural fibers; and
mixtures thereof.

3. The method as claimed in claim 1, wherein the thermoplastic polymer is selected from the group consisting of:
polyamides, polyamide 6 (PA-6), polyamide 11 (PA-11), polyamide 12 (PA-12), polyamide 6,6 (PA-6,6), polyamide 4,6 (PA-4,6), polyamide 6,10 (PA-6,10), polyamide 6,12 (PA-6,12), block copolymers containing amide monomers and other monomers;
aromatic polyamides;
fluoropolymers comprising at least 50 mol %, of monomers of formula (I):
CFX═CHX′ (I)
where X and X′ independently denote a hydrogen or halogen atom or chlorine) or a perhalogenated alkyl radical;
polyolefins;
thermoplastic polyurethanes (TPUs);
polyethylene terephthalates or polybutylene terephthalates;
silicone polymers; and
mixtures thereof.

4. The method as claimed in claim 1, wherein the nanotubes are constituted of carbon nitride, boron nitride, boron carbide, boron phosphide, phosphorus nitride or carbon boronitride.

5. The method as claimed in claim 4, wherein the nanotubes are carbon nanotubes.

6. The method as claimed in claim 1, wherein the nanotubes represent from 0.5 to 30% of the weight of the thermoplastic polymer.

7. The method as claimed in claim 1, wherein the volume ratio of the continuous fibers to the polymer matrix is greater than or equal to 50%.

8. Composite fibers capable of being obtained according to the process as claimed in claim 1.

9. The composite fibers as claimed in claim 8 comprising noses, wings or cockpits of rockets or of aircraft; sheathings for offshore hose; motor vehicle body components, engine chassis or support parts for a motor vehicle; or of framework components in the field of construction or bridges and roadways.

10. The method as claimed in claim 2 wherein said fibers of drawn polymer comprise polyamide 6 (PA-6), polyamide 11 (PA-11), polyamide 12 (PA-12), polyamide 6,6 (PA-6,6), polyamide 4,6 (PA-4,6), polyamide 6,10 (PA-6,10), polyamide 6,12 (PA-6,12), high-density polyethylene, polypropylene, or polyester; said glass fibers comprise E, R or S2 glass fibers; and said natural fibers are flax, hemp or sisal.

11. The method as claimed in claim 3 wherein
said polyamide block copolymers comprise polyamide and block polyamide and polytetramethylene glycol (PTMG) blocks
said aromatic polyamides are polyphthalamides;
said fluoropolymers comprise monomers of formula (I):
CFX═CHX′ (I)
where X and X′ independently denote a hydrogen or a fluorine or chlorine;
said fluoropolymers are selected from the group consisting of polyvinylidene fluoride (PVDF), and copolymers of vinylidene fluoride with hexafluoropropylene (HFP), fluoroethylene/propylene (FEP) copolymers, copolymers of ethylene with either fluoroethylene/propylene (FEP), or tetrafluoroethylene (TFE), or perfluoromethyl vinyl ether (PMVE), or chlorotrifiuoroethylene (CTFE); and
said polyolefins are polyethylene or polypropylene.

12. The method as claimed in claim 6 wherein the nanotubes represent from 0.5 to 10% of the weight of the thermoplastic polymer.

13. The method as claimed in claim 7, wherein the volume ratio of the continuous fibers to the polymer matrix is greater than or equal to 60%.
